(19) United States
(12) Patent Application Publication
(10) Pub. No.: US 2009/0161204 A1
(43) Pub. Date: Jun. 25, 2009

(54) Splitter

(76) Inventor: Zafar Iqbal, Hyderabad (PK)

Correspondence Address: NATH & ASSOCIATES PLLC, 112 South West Street, Alexandria, VA, 22314, US

(21) Appl. No.: 12/232,285

(22) Filed: Sep. 15, 2008

(30) Foreign Application Priority Data
Sep. 14, 2007 (PK) 1098/2007

(51) Int. Cl. G02B 21/20; G02B 27/10

(52) U.S. Cl. 359/375; 359/618

(57) ABSTRACT

An optical gadget is disclosed which in one embodiment is fixed at a location in an orthogonal position on the central optical axis of an operating system, such as a microscope, that may not be truly orthogonal. The gadget includes a hollow tube and a mount for attaching the tube to a control optical axis of an intended orthogonal system such as a microscope.

### BACKGROUND OF THE INVENTION

First time in the history of the world that a paradigm operating in real time and space is meticulously adjusted within the existing system of relative time and space to control and change existing paradox of time and space of existing technology, by providing permanent axis and advance view of guiding parameters to anchor oncoming changes under universally readable prescribed limits. In the present system (splitter) image observed (object) and image retrieved (in computer) show total “equivalence” in analysis and operative laws because magnification is a part of normal vision, what was invisible before is visible now or our vision is extended and expanded under the strict jacket of real time and space, the person can use his normal mental and manual dexterity in new world without any orientation and fear. Because of the extended vision provides tactical overview of ongoing operation without or beyond subject/object dichotomy.

Up till now science and technology misguided us that means are optional and results are obligatory to prove methodology surpasses norms of Divine creation, laws of nature and cosmic causality, when orthogonality (splitter) proves that means have absolute superiority over the results, because means or laws (science) which not only teach us about the status and measure of methodology (technology) but also contain technology under prescribed limits to prove the forgotten truth, that “means” justify “ends”.

Science (laws) and technology (means) do not work concomitantly neither they show homogeneity nor complementarily, world is facing century old paradox that if they follow science in digital or linear mode (where the world follow previous: step) results are faulty and if they follow science and technology in parallel or analogue mode (where a person skilled in the art improvise every step according to the situation) science and technology show faults.

### History of Surgical Microscopes

In 1921 microscope was first used in ENT

In 1942 microscope was introduced in opthalmology.

In 1962 microscope was used in neuro surgery.

In 1992 electronically controlled navigational microscope was introduced for neuro surgery.

In 2000, almost eighty years after the introduction of microscope it was realized that as image ascends from “objective” to “eyepiece” it perpetually concedes in space and recedes in time, which distorts magnification and magnification over masks “resolution” which is in reality the essence and true measure of a microscope.

To isolate “resolution” from distortion of magnification and magnification from dispersion in time and space “virtual reality” (VR) and “augmented reality” (AR) were introduced for “precision point engagement” in “critical time limits”.

Advance guidance in real time and space” is made possible through this invention when objective reference point operate at orthogonal (space) end to perpetually generate timeless images, retrieved through timeless medium (hollow tube of splitter) for final analysis of object and synthesis of operative directions at subjective reference end (time) by computer to simultaneously visualize total potential of an object (effect) and corresponding operative forces (cause).

Orthogonal dimension of space provides reliable and replicable view of the object in the form of “critical space limits” to prime dimension to retrieve this image in real time to construct total reality (by computer). Total reality then undergoes analysis digitisation and synthesis in cyberspace to manifest in predictable operative directions to provide free and easy access, to operate in the world of unpredictable time and space (Spatio temporal world).

Purposely two very advanced technologies are selected, working in “induction” and “deduction” dimensions to demonstrate that shortcomings at the end of these two technologies became blessing in disguise. When immutable dimensions from each technology are ultimately merged to manifest as “splitter”.

Electronic bidirectionality of neuro surgical microscope (FIG. 2) is changed into “visual bidirectionality” (FIG. 4) and “Orthogonality” used in corneal mapping (FIG. 3) in eye surgery is taken to provide universally replicable and readable images.

### Analysis of Relatives World:

1. There are three dimensions of space whereas a man can understand only two dimensions and act in one direction.
2 There are three time zones past, present and future, where future zone is obscure.
   The Inspiration which Compelled to Solve these Problems:
2. ‘Direction’, ‘Time’ and ‘Space’ are a priori of human vision or human vision is intuitionally linked with direction, time and space.
3. Human vision is “tuned” with direction and “timed” with space.

### Turning Point of Inspiration:

Lately in all surgical microscopes, “virtual reality” (where partial image of operating microscope is matched with computer generated total image) and “augmented reality” (where total image of computer is projected on partially visible object of microscope) are interfaced with computer through “electronic bidirectionality”. Efforts were made to construct “visible bidirectionality” independent of the existing optical system, operating in universal paradigm mutually focused with the existing microscope on the same object to retrieve its complete image.

The present microscope operates with the partial image having the following characteristics:
i) Direction is variable.
ii) Time is serial (temporal)
iii) “Whole” cannot be constructed on this image for total analysis.
iv) Human pace will not equate with pace of event, because the image recedes in time and concedes in space.

### The Reasons for Choosing Surgicalmicroscope as a “Prior Art” or Reference Background of “Splitter”:

1. Because most advanced data matching (virtually reality) and data patching (augmented reality) are used in advanced surgical microscopes to bring total reality in sight but specified accuracy is not guaranteed because the process is structurally bound, unipolar, and the final move is based upon individual judgment of operator.
2. This is the only technology where highly expensive (diamond knives) super sharp, and calibrated instruments are used and the events unfold so fast that there is no time, to pause, to think, and to act. It has been calculated that negligence of a one fifth of a second that is two hundred microseconds can cause irreparable damage.
3. Any machine (here surgical microscope) that embraces huge cost and intimacy with the surgeon's creativity should work as extension of his soul like subconscious of human consciousness. Predominant reality is surgery not surgical microscope. Technology should streamline human desire and future vision so that surgeon can start, maintain and regain his operative posture irrespective of his experience, mental pace and operative dexterity.

### The Existing Forces Available to Design “Splitter”:

1. Visible world and an invisible world show unvarying symmetry and proportionality with verifiable correspondence between real time and real space. To advance from visible to invisible world, immutable co-ordinates can be used to operate in universal paradigm.
2. Orthogonality (mutually perpendicular) where every image is universally readable and replicable in the following manner:—
   a) Profile display can be quantified for direct access to all functionality (algorithm) at all time to stabilize objectivity by changing established static process into dynamic “visual bidirectionality” we can defy relative spatio-temporal world and delve, in the error free visible world of predictability as long as desired.
      Because of visual bi-directionality of orthogonality a parallax world of order is created between object and its image (conjugation) to provide predictable directions to create:
      i) Environment of visible predictability: when all operative dimensions are present with computer generated visible end results;
      ii) Environment of error free technology: when prescribed limits of universal order totally measure and scrutinize spatio-temporal world;
      iii) Cutting edge technology; when advanced guiding system help to always at safe and easy location with equally safe and easy operative operations.
   b) With the help of computer the image can be changed from 2D image into 3D image.
   c) The more precise the information, the more exact subsequent analysis and strategies, and more efficient use of operating time.

### SUMMARY OF INVENTION

An optical gadget is designed which set aside real technology in minor and mega dimensions, liberating output of skill inadequacies, inherent in human nature and structure of machine, by providing advance guidance in real time and space, through universally readable parameters for anticipation and prediction to achieve only perfect state of art preconceived end results.

An optical gadget is designed when placed at required position in any orthogonally operating technology, assist and ensure perfect and predictable outcome by obviating total inadequacies of mind and machine, It works in Metaphysical realm, “SPLITTER” as the gadget is called. It explicitly splits and create higher time zone of real time and space, to monitor and control changes in lower time zone of relative time and space.

Real space furnishes universally readable operating dimensions by undergoing analysis and synthesis in cyber space to afford total and independent guidance in digital mode by extricating human involvement through advance guidance, automation or robotics.

Real time ensures all endurance to allow human involvement under prescribed limits to streamline operative steps into required sequence and desired operating pace according to demand of situation.

Splitter has totally offset the present concept of cause and effect where effect justifies the means to primordial primacy of means over cause.

First time in the history of the world that a paradigm operating in real time and space is meticulously adjusted within the existing system of relative time and space to control and change existing paradox of time and space of existing technology, by providing permanent axis and advance view of guiding parameters to anchor oncoming changes under universally readable prescribed limits. In the present system (splitter) image observed (object) and image retrieved (in computer) show total “equivalence” in analysis and operative laws because magnification is a part of normal vision, what was invisible before is visible now or our vision is extended and expanded under the strict jacket of real time and space, the person can use his normal mental and manual dexterity in new world without any orientation and fear. Because of the extended vision provides tactical overview of ongoing operation without or beyond subject/object dichotomy.

There are only three fundamental cosmic forces in the world of science and technology

### 1) Space 2) Time 3) Direction

On the basis of nature of time two time zones are created/demarcated to operate on common object
1) If time is real, given dimension can be stabilized into specific operative direction for predictable change this is why it is called “Higher time zone”.
2) If time is relative then it is always human effort to select one dimension and one operative direction for desired end result. This is the relative world where we are living and it is called “Lower time zone”
   Splitter totally animated with the very spirit of orthogonality demarcates these two time zones and simultaneously guide and guard in advance the lower time zone to operate with the directions of error free world of higher time zone.
   Two more advantages of the splitter are
1) It creates unbroken bi-directional relationship with the dimensions of object to perpetually generate universally readable parameters.
   When in lower time zone relationship is interrupted, it is only established when man interfaces with the technology (here microscope).
2) Splitter depending upon power of video camera at the objective end and computer at the subjective end can analyse object as a whole or in the self contained sub units in higher time zone in cyberspace to extend with tolerable precision in future to see the end results before initiating the operation.
   This proves
How to set aside real technology
Filter out human and machine inadequacies
Universally readable advanced guidance
Anticipation and prediction with permissible precision
   The system is based on orthogonality is:
i. SIMPLE: where functions overwhelm the aesthetics and size of the tool.
ii. HUMAN: dimensions of image totally approximate human dynamics.
iii. UNIVERSAL: blessings of science in the form of “speed” and “ease” are provided at low cost in small size.
iv. FUTURISTIC: it extends accompanying technology to operate in future time zone.

### The Guiding Principals to Designs, Fabricate and Assemble “Splitter” (Refer to FIG. 28)

It is impossible to operate in higher time zone without proving that Metaphysics is a world very much explicable, explainable and explicitly demonstrable in empirical world by analytical geometry and synthetic mathematics.

Physics is a world of “Conditionality” where time and space show heterogeneity. To deal with this world all human faculties of eyes, mind and hands add and subtract space and time to be on the right target with right direction in right time.

In higher time zone world of “Conditionality” is interlinked with verifiable bi-directionality with world of “Unconditionality” commonly known as Metaphysics, where time and space are homogenized to create world of total neutrality where there is no constraints of time and space. Here only demarcated targets are filtered out by computer for human dexterity for visible and predictable change and liberating human vision of objectivity and time of subjectivity.

We can reach or create world of metaphysics or homogeneity by:
1) Paradigm
2) Resolution

### Paradigm:

There are three prerequisites to transform world of heterogeneity into world of homogeneity of time and space:
1) REAL SPACE or ‘critical space limits’ where no single dimension is required to complete it.
2) REAL TIME or ‘zero time duration’ where no extra duration is required to capture it.
3) REAL DIRECTION or ‘zero axis’

Primordially human vision line and 67% cerebral cortex is tuned and tilled with direction space and time.

All these forces compliment and galvanize each other. Without ‘critical space limits’ time cannot be digitised and without real time ‘critical space limits’ cannot be stabilized. At the end it is the direction which critically scrutinizes and precisely homogenizes time and space into:

1) UNIVERSAL so that time and space complex can be analysed at any place and at any time.
2) INFINITY application of paradigm at all times and at all places.
3) PERMANENCE total immunity from time and space restrictions.
4) COMPACTNESS clarity of targets, simplicity in configuration, easily manageable operations to conserve energy and preserve end results.

Direction provides architectonic to streamline geometry of orthogonality and also designing of splitter to embody all the creative vertical and horizontal powers which make orthogonality functional.

Eventually direction helps us to reach the Metaphysical principle that there is only one direction of “Universal vision” to identify and inherit back total dimensions of an object to generate conjugate image for absolute equivalence in identification, analysis and application of operative laws.

When splitter is placed at the required optical axis for its functionality in any technology (here Microscope) to operate in orthogonal relationship with the object, it splits the “Duality” by picking up real dimensions in real time from the same dimensions of object from where existing technology retrieve relative dimensions in relative time. Splitter also helps us to visualize two time zones of Meta-Physics and Physics and also that how they are reciprocally interlinked.

Higher time zones of ‘Metaphysics’ create, condition and control the world of ‘Physics’.

Once Metaphysics is totally activated it can explicitly prove that the science and technology is no more an abortive exercise as presently thought. It has completed proverbial full circle to be a self sufficient entity. It can create reliable, verifiable and replicable objectivity, totally extricating human interface so much so that even human presence (Vision) is not required to confirm it to prove the forgotten truth that cosmic causality is far accurate, precise and compact then the collective human rationality.

Man is free to stabilize his own objectivity to the independent world of science and technology, to create world of zero tolerance and abridge digital divide to prove that means have axiomatic primacy over end results.

Fully functional Metaphysics in higher (real) time zone would guide you that:
1) Main driving forces in the form of time and direction are invisible and operate in zero duration. They can only have zero relationship with the space known as ‘Dot’ where coordinates are in none associations, mobile but universal. Hence, orthogonality (mutual perpendicular).
2) Orthogonality is proved to be mother of all paradigms where Physics and Metaphysics tie nuptial note through real time and real space.
3) Splitter is a device which can harness total spirit of orthogonality in length and breadth.
4) This entire cosmos is designed to conserve human energy and preserve scientific heritage.
5) If you know how to use your vision line then there is a world of certainties right at the place of world of probabilities.
6) You can easily set aside real technology in minor and mega dimensions.
7) You can liberate yourself and system from skill and functional inadequacies once you establish independent and replicable world of science and technology.
8) You can extend with finite precisions into future for advanced guidance (visible predictable parameters) to anticipate and predict.
9) You are operating in the world where effect modifies forces of cause, then to blindly proceed with cause to create effect.

10) If you insist on justifying ends you are a causality violator. All forces of nature are there to inspire and guide, to infuse aesthetics and perfection in preconceived end results and to prove that you are born to be causality invigorator.

Resolution:
1) Orthogonal image is a graphic representation of Metaphysical world; infinitely symmetrical that expands or contracts in isometric form. To keep its wholeness, or totality by equal distribution of time and space.
2) It explicitly demonstrates the very spirit of orthogonality in horizontal and vertical dimensions.
3) Symmetry or wholeness can be analysed in like self contained predictable units where individual units are highlighted by before and after units.
4) All units individually and collectively can be demarcated for engagement with precision and sequence liberating human vision line and time line.
5) This is the world where conception exceeds whole situation or map expands beyond territory to see pace of event more then operating pace to conserve energy and end up with preconceived end results.
6) Orthogonal image perpetually updates itself in isometric paradigm and simultaneously upgrades non-orthogonal image right then and there liberating from the entire work load to get assistance from virtual or augmented realities.

We are almost at the edge of controlling technology with the same ease as we control the cursor with the mouse.

### Embodiment

This part of the document describes in detail how the spirit of an idea, principle or paradigm is harnessed in a working system.

1. Straight line is the prime metaphysical foundation of consciousness and cosmos. It is the straight line which unfolds the innate potential of mind and matters
2. Straight line in the form of universal vision on one end unfolds the total identification of an object and on the other end total visual dexterity of man as if mind and matter are timed (TIME) and tuned (SPACE) to straight line (COSMIC CONSTANT).
3. Total sanctity of straight line is incarnated and incorporated in orthogonality. It is the orthogonality that extends and expands straight line in proportionality and absolute symmetry without affecting the inherent potentiality of straight line taken as a prime dimension.
4. Orthogonality is that axiomatic and universal paradigm which truly imitates, emulates, and even excels total human potential singularly and collectively in predetermined order of:
I. Visual dexterity
II. Mental dexterity
III. Manual dexterity
I) For visual dexterity orthogonality provides normal and natural extension of human vision in metaphysical (invisible) world in length and breadth through pure optical resolution.
II) For mental dexterity orthogonality provides normal and natural world of a-variance through universal vision line in the form of a-priori, an ought to operate in a world of absolute necessities and definite possibilities
III) For manual dexterity orthogonality provides free excess of measured and scrutinized human familiar operative parameters, to choose own steps of sequence or operative line.

In nutshell, if line of vision provides isometric vision of an object mind accepts it as if it was expected and human hands carry out freely accessible changes of new-conceived world.

Orthogonality guarantees that modifying the technical effect produced by a component of a system neither creates nor propagates side effects to the other component of that system.

5. In two dimensional Euclidean spaces, 2 spaces are orthogonal if their dot product is zero that is they make an angle of 90 degree or pi/2 radians. Because mutual perpendiculars are in the realm of non association.
6. Orthogonality operates in three stages:
I. When both coordinates are variables;
II. When one coordinate is a-variable and the other is variable; and
III. When both coordinates are a-variables.

In SPLITTER both coordinates are a-variables with a difference that primary dimension is real time (hollow tube) and the secondary dimension which is known as orthogonal is space a-variable i.e. providing critical space limits, timeless image or subtle dimensions for total identification.

7. Orthogonality streamlines equitability and empathy between human nature and technology.

The basic dynamics of orthogonality is not affected by “time”, “space”, and “form” constraints. It is unequivocal and unique open ended system of infinite/definite possibilities, because it expands as isometric seamless world in prescribed space and direction to create whole new world of observations, assessments, verifications, innovations and productions in minor and mega dimensions.

Why this innovation is called “Splitter”, because it splits duality and separates:
ii) Real world from relative world.
vi) Metaphysics from physics.
vii) Quantitative world from qualitative world.

### Technical Specifications:

As far as the Technical Specifications of Splitter are concerned, we submit as follows:
PURPOSE: Ultimate guidance with compensating inadequacies of mind and machine.
MODE: Optics
INPUT: Visuals (2-D/3-D Images) for total identification.
FUNCTION: Digital/Analogue for total identification and error free operation. Unbroken continuity of functionality is provided by orthogonality because of bidirectionality when man can blink but system will not blink.
OUTPUT: Universal operative directions based upon qualitative analysis readable at all times.
APPLICATIONS: Diamond cutting, robotics, optics, lasers, microelectronics, micro mechanics and designing evaluation and construction in any field

### Example

1) Raw diamond is first analysed quantitatively and qualitatively in universally readable parameters.
2) The gadget suggest numerous options of best valued products
3) During the process of cutting whenever a gadget is consulted it suggests the best possible course available at that time.
   Forces which Guide and Guard “Universal Line” of Splitter
   I. Straight line
   II. Symmetry of cosmic time and space

### III. Orthogonality

### IV. X, Y, Z, Coordinates

### V. Resolution

1. Straight Line which Symbolizes the Most Fundamental Metaphysics:
Optical depth of human vision is more profound then optical depth of sunlight. We can use human vision in “skeet” firing which is not a game of chance but very much a sport of choice similarly we can use vertical straight line to construct a “sundial” anywhere in cosmic world.

### II. Symmetry or Homogeneity of Cosmic Time and Space:

In cosmic world time and space are two absolute entities which can restrict or modify operative circumstances. Every physical law in every physical domain contains explicitly or implicitly space time relationships. Explicit time and space exhibit homogeneity to conserve human energies and preserve scientific heritage. Because of time and space homogeneity physical phenomenon is always the same; we can repeat Archimedes principle of buoyancy anywhere any time.

### III. Orthogonality:

Orthogonal is a simple adjective which is a generalization of “perpendicular”, means right angle. In Greek “Orthos” means “straight”. Straight line still remains primary dimension for core application and the second dimension which is added perpendicular to it is called orthogonal, Orthogonality is commonly used in:
a. in scanners where light moves orthogonally;
b. in designing power transmissions of vehicles;
c. in FIG. IV, surgeon is examining orthogonally taken photographs of human cornea for qualitative analysis before surgery.

In the matrix of Orthogonality, qualities of observer and observed are preserved and are replicable.

Orthogonality provides ideal and pure relationships between independent (vertical) and dependent (horizontal) invariables.

### Compactness:

Compactness is the property of orthogonal design, which provides human familiar parameters to easily fit inside his head. We do not need a manual to operate, nothing obtrude between human mind and his work.

Orthogonality is a relationship where input is always equal to output or human pace is equal to event pace. It is one to one relationship, there is one and only one way to change/control/operate.

Total demarcation of operating targets for which we are presently using workstations fed by CAT scan and MIR systems to display three orthogonal views of a patient. Each orthogonal view is represented in two space dimensions and three x, y, z coordinates as evident from attached literature, titled as “A Precision Localiser to Enhance Accuracy in Image-Guided Surgery”.

### IV. X, Y, Z Coordinates:

Refer to “EYEMAP” to understand X, Y, Z alignment.

### V. Resolution:

The real dichotomy between the existing science and SPLITTER is “image” to science everything is sacred which can be measured in ‘FIG. I’, resolution, magnification and distortion of image in time and space are shown. There is no way to subtract or isolate the magnification from time and space and resolution from magnification. Resolution being the real essence of the total complex, this complex of resolution magnification and time and space has created indefinable difference and distance between observer's objectivity and subjectivity. When image generated by SPLITTER is based upon Orthogonality guarded on one end by straight line and the other end by X, Y, Z coordinates comprises of three timeless components “compact in nature”.
1 Real time and space are enfolded in magnification.
2. Magnification provides real horizontal dimension isometrically proportional to object as a base or foundation.
3. Resolution is created as symmetrical pyramid in pure vertical dimension as shown in FIG. XVI. Thus SPLITTER establishes its own work station inside the existing system (Microscope) to operate in two time zones the higher time zone is far advanced in pure analysis and synthesis and provides ultimate operative directions depending upon speed of video camera and computer to:
   a. create true bipolar world of real time and space (Metaphysics) in the centre of the world of relative time and space (Physics).
   b. Achieve visible end results with predictable time and space.
   c. Provide universal humanly familiar readable parameters of total reality (compactness) to filter out errors of mind and machine.
   d. Generates total reality in cyber space for total identification and manipulation in six dimensions and three X, Y, Z coordinates.

If image is the criterion there is no comparison between the image output of SPLITTER and that of microscope (here used as a prior art).

If magnification is the linear comparison of image with object, image is absolutely proportional in dimensions on both sides of object in SPLITTER because it operates in the centre of microscope. Thus when we increase or decrease magnification, image of object remains in the centre of monitor. When in microscope outlets for image is indirect and lateral (FIG. 22), there is disproportional relationship between object and its image, when we increase or decrease magnification image of the object moves eccentrically, reducing the pure vertical pyramidal development of resolution. Eventually we require a bigger aperture to capture this image, readjustment of microscope to bring image back in the centre of monitor and it is impossible to construct a “whole” for total analysis on this image.

If you compare images generated by SPLITTER and microscope (FIG. 20) because of pure resolution which is twice in height then the image of the microscope (where true resolution is totally obscured, compare FIG. I with FIG. XVI) the extra height in vertical dimension reveals the un-manifested (Meta Physical) world which provide us the advanced view with absolute and transparent demarcations for visible predictability (visible future) and error free zones for safe manipulations to compensate inadequacies of a machine and ambiguities of human mind. If you use a video camera twice the human visual speed (24 frames per second) it is left to every ones fertile imagination that how much real time will accumulate at every passing “seconds”.

Besides economy, aesthetics and human ergonomics, microscopes are designed on the paradigm of average inter pupillary distance of human eyes the choice of 4.25 mm (internal diameter of “SPLITTER”) was not based on any scientific grounds or free will, it was an absolute pre-destination, because only 7 mm safe zone was available without disturbing the external and internal configurations and functional dynamics of microscope that include illumination and magnification with the exception that separate magnification chamber (please see FIGS. VI and VII) is designed in the centre below the tube of SPLITTER. Curiously enough when a tube of smaller diameter was tried no change in quality of image was observed.

| | |
|---|---|
| SPLITTER | MICROSCOPE |

QUALITY OF IMAGE

| | |
|---|---|
| No beam splitter is required hence surgeon's | Image is not crisp because of its division |
| view is not interrupted and crisp image is | between surgeon and video camera through |
| available at low illumination. | beam splitter. |
| | See FIG. No. 22 |

CENTRALITY OF IMAGE

| | |
|---|---|
| Image remains in the centre when you | Image moves eccentrically when you |
| change the magnification. | increase or decrease magnification. |

GUIDANCE OF IMAGE

| | |
|---|---|
| Image of SPLITTER is explicit | |
| representation of orthogonal paradigm here | |
| symmetrical magnification is anchored at | |
| right angle to isometric resolution. | |
| This image will provide complete | Image cannot provide real guidance for |
| topographical identification for computer, | planning operative strategies. Available |
| observer, there (where operation is taking | resolution in microscope is not sufficient to |
| place) or far with electronic co presence | transcend from a spatio-temporal world to |
| which is only possible with orthogonal | timeless a-temporal world. |
| “whole” to independently analyse, search, | |
| evaluate and guide operation from remote | |
| place. | |

No doubt resolution and magnification are the integral part of each other but in the realm of analysis and ultimate guidance magnification has no comparison with resolution.

| | |
|---|---|
| SPLITTER | MICROSCOPE |

GENERATION OF IMAGE
(Refer FIG. No. 20)

| | |
|---|---|
| Image generated by SPLITTER is based | Image generated by microscope depends |
| upon straight line of orthogonality. | upon non-orthogonal dimensions. Here time |
| | and space follow diverging path. As the |
| Here time and space follow converging | image ascends it recedes in space and |
| path, they are synthesized and homogenized | concedes in time and everything undergoes |
| in magnification. | juxtaposition (side by side) in horizontal |
| | direction. Heterogeneous forces of time and |
| Magnification is symmetrical, concentric, | space create asymmetrical, eccentric and |
| proportional and isometric, with vertical | disproportional magnification known as |
| cone of resolution. | lateralization eventually arresting resolution |
| | of image configuration |

CAPTURING OF IMAGE

| | |
|---|---|
| Very small aperture of C-Mount is required | As evident from the size of the image you |
| to capture this image because of pointed and | require larger aperture and higher |
| conical configuration of image resolution. | illumination to capture it. |

### According to Merriam Webster's Dictionary

Definition: - Real-time : time in which the occurrences of an event and report or recording of it are almost simultaneous

Real-time Adjective: Pertaining to work of computer operation in which the computer collects data computes with it and uses the results to control a process as it happens.

### How “Splitter” Operates:

It provides universal operative tolerance in the form of self centration, self focusing, self searching, self identification, self manipulation and ultimately TOTAL AUTOMATION. Creating apocalyptic change from the world of “assistance” to the world of ultimate “guidance”.
1. Space tolerance based upon “critical space limits” to constantly generate timeless image.
2. Time tolerance Allows enough time to operator for “precision point engagement” of object.
3. Operative tolerance to lead change firmly rooted in present with preconceived directions on chosen space dimensions for required end results.
4. Mirror image symmetry the phenomenon was discovered by Frank Yang and Lee that the object and mirror image obey the same law and are functionally equivalent in every way.

### Human Limitations:

Human being can perceive only two space dimensions and operate with one-space dimension (direction).

IN PHYSICS HUMAN POTENTIAL ACTUALIZES THE WORLD OF POSSIBILITIES; IN META PHYSICS INHERENT POTENTIAL OF AN OBJECT GUIDES A MAN TO ACTUALIZE POSSIBILITIES.

THE WORLD OF RELATIVITY IS ONLY CONFINED TO TIME AND SPACE AND THE WORLD OF REALITY (METAPHYSICS) IS CONFINED TO CAUSE AND EFFECT.

Here entire system is an extension of operator. It is a pure human technology where no familiarization is required. When in temporal world of relative time and space operator is an extension of system where he moves from one obscure now to another obscure now without any concrete knowledge of prevision and future hence he always tries to adopt direction where he feels safe and accustomed.

### Advantages of “Splitter”

1. It was possible to capture this image through a hollow tube with internal diameter of 4.25 millimetres.
2. Very few optical components are required.
3. A super sharp image is created at low illumination without image loss or dispersion.
4. Better contrast and greater sense of visual depth because of low illumination.
5. Totally separate visual relay system with its own magnification, X. Y translation and focusing system.
6. This optical device acts as a “viable technology and evaluation system”. A perfect source of inspiration and innovation where operator can blink but system will not blink.
7. It provides optical port, which accepts all available optional accessories.
8. Here human pace equates with event pace.

### Dimensions of Splitter's Image

Discovery of this total image, which seizes is a discovery of epic proportion because it is first time revealed to mankind that a person can
1. DISRUPT NEXUS OF CAUSE AND EFFECT
   By changing time and space paradox into parallax where we can work in real time and space.
2. ISOLATE SUBTLE OPERATIVE FORCES WHICH OPERATE BETWEEN CAUSE AND EFFECT.
3. QUANTIFY OPERATIVE FORCES INTO DEFINABLE DIRECTIONS
4. IT IS THE ONLY SYSTEM WHICH HAS INHERENT POTENTIAL FOR
   a. SELF CENTRATTON
   b. SELF FOCUSING
   c. TOTAL AUTOMATION
   d. SELF MANIPULATION
   This is the first time that the world will have a system in their hands for total ROBOSURGERY without any human intervention or, a self contained and self controlled robot.
5. Because the person can create “whole” on this image and project it in instant he has permanent axis and permanent view in his hand to anchor relative changes in prescribed limits
6. This image matches and excites the maximum human visual arid mental capacity
8. This image provides a network of “electronic co-presence” between machine, operator and outside world to interact in real time.
9. This image brings about apocalyptic shift from the rule base system to system of its own rules where we can enter in future with the map preceding and exceeding operating territory.
10. This image first time in the history has provided us a unique paradigm.

a. Where we can design self modifying networks

b. Create chosen experience to behave as you have imagined it should

### BRIEF DESCRIPTION OF DRAWINGS

Prior art, fabrication of vital parts of “SPLITTER” are so explicitly sketched and implicitly sequenced that there is a comprehensive linkage of figures for progressive SPLITTER'S assembly. Yet brief description of each drawing is given to fulfil the demand of required document.

FIG. 1 shows 3-D schematic features of three steps magnification microscope along with generated image.

FIG. 2 depicts an electronically controlled navigational microscope for neuro surgery;

FIG. 3 depicts a surgeon is reviewing the future surgical plan by examining orthogonally captured image of human cornea.

FIG. 4 shows an orthogonal visual bi-directionality created by SPLITTER.

FIG. 5 depicts an assembled unit with a SPLITTER.

FIG. 6 discloses the steps of a fabrication of the present invention, where:
DRAWING 1 shows a bottom plan view of an existing three-step magnification microscope with two optical chambers;
DRAWING 1A shows the two optical chambers of DRAWING 1;
DRAWING 2 shows an existing lever of two optical chambers;
DRAWING 3 shows a special optical chamber with micro-gear strip;
DRAWING 4 shows the special optical chamber mounted on the existing lever of the two optical chambers; and
DRAWING 5 shows a bottom plan view of the assembly of DRAWINGS 1, 2 and 4.
   FIG. 7 shows bottom perspective view of existing three steps microscope especially improvised for splitter;

FIG. 8 top view of microscope;

FIG. 9 shows top perspective view ‘A1’ and a lateral view ‘A2’ of splitter.

FIGS. 10, 11 show how a SPLITTER is installed in existing microscope.

FIG. 12 is a front elevational view of a SPLITTER mounted in a microscope.

FIG. 13 is a perspective view of a C-Mount adapter.

FIG. 14 video camera ‘F’ attached to C-Mount adapter ‘E’.

FIG. 15 depicts perspective view of a microscope showing two eyepieces attached on either side of a centrally mounted splitter.

FIG. 16 is a schematic presentation of SPLITTER with its unique image of pure resolution.

FIG. 17 is a perspective schematic presentation of an existing microscope with an attached SPLITTER.

FIG. 18 depicts a perspective view of a nonocular microscope.

FIG. 19 is a perspective view of a microscope with a splitter mounted thereon and with the following detailed variations:
DRAWING 1 is an elevational view of the head of an opthalmoscope;
DRAWING 2 is an elevational view of a head;
DRAWING 3 is an elevational view of an ophthalmic head having a tube attached thereto; and
DRAWING 4 is a lateral view of a pattern projector.

FIG. 20 displays drawings showing configurational and geometrical differences of images retrieved through splitter on the left side and conventional microscope on right side.

FIG. 21 depicts drawings showing optometrical symmetry between the paradigm of ‘orthogonality’ and structural relationship of SPLITTER with its unique magnification system and the retrieved image.

FIG. 22 depicts drawings showing the effect of non-orthogonal dimensions on generating a partial and incomplete image through the lateral outlet of the microscope.

FIG. 23 depicts a drawing show how SPLITTER enhances the workability of complimentary technology.

FIGS. 24-25 depict drawings that show how a Splitter creates a quantum shift in the configuration of optional accessories.

FIG. 26 depicts drawings of a seamless tube that is part of the SPLITTER.

FIG. 27 depicts drawings showing the various applications of the SPLITTER.

FIG. 28 depicts drawings showing the relationship and comparison of orthogonal and non-orthogonal images with operating orthogonality of SPLITTER.

### DESCRIPTION OF THE PREFERRED EMBODIMENTS

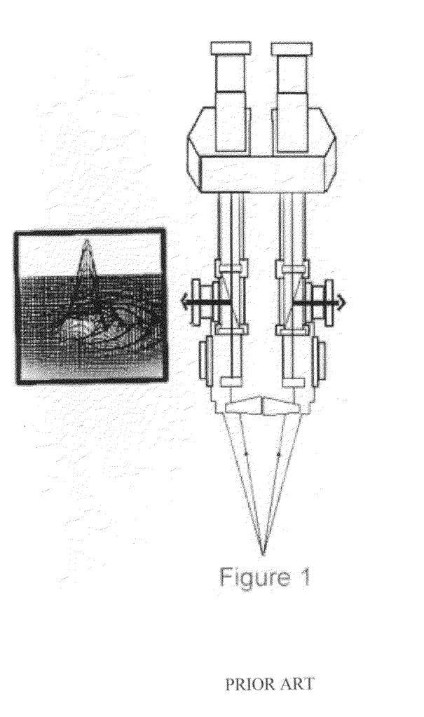

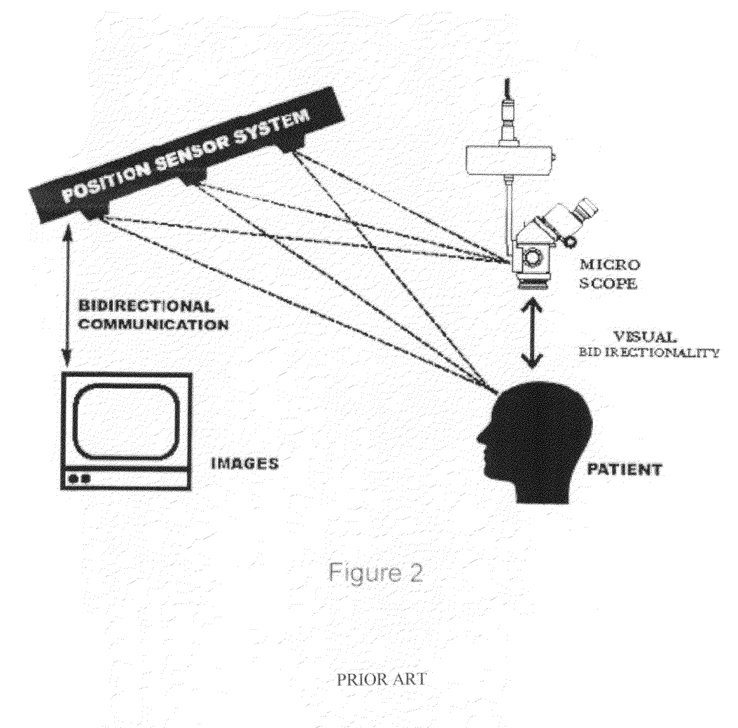

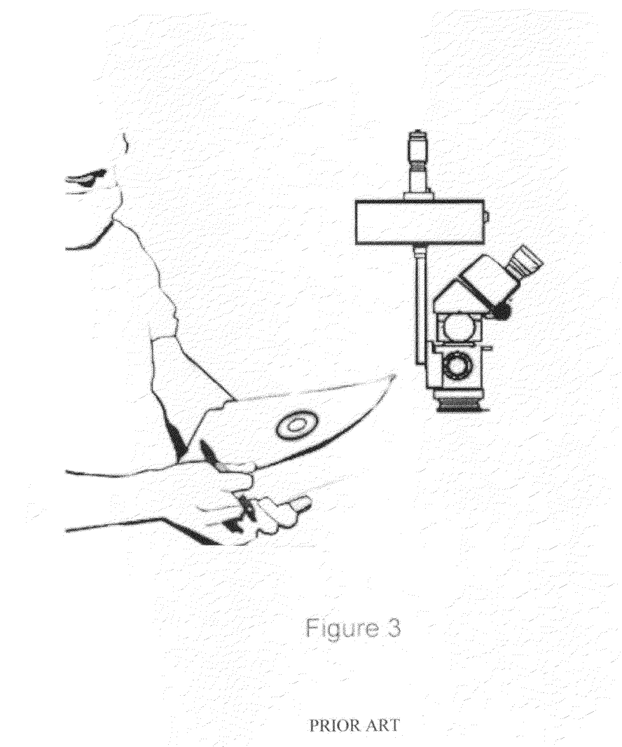

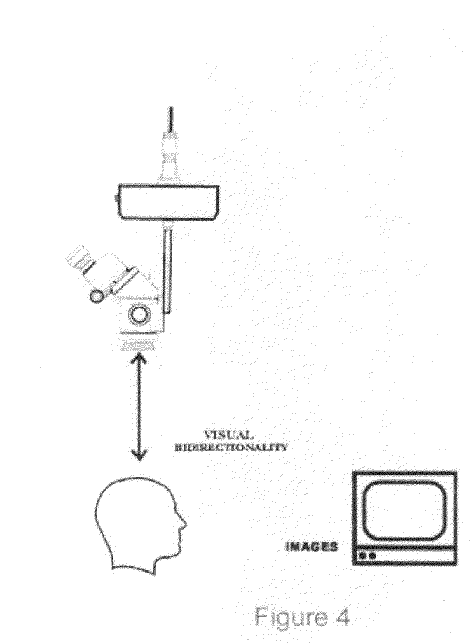

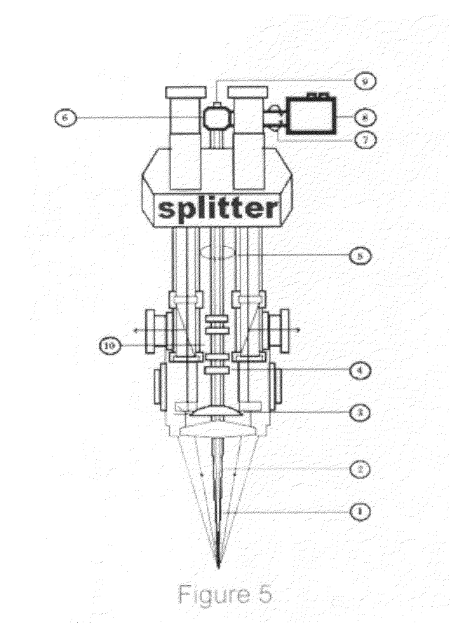

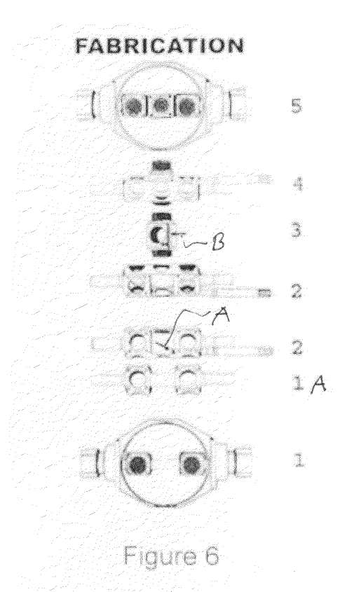

FIG. 1 shows 3-D schematic features of three steps magnification microscope along with generated image.

It displays existing microscope with its image. Because image fails to provide total information virtual and augmented realities are inducted in system to “upgrade” the image based upon individual prerogative of operator (there is no advanced guidance).

Microscope displays that little space where we have to install splitter without disturbing the configurational and functional integrity of machine.

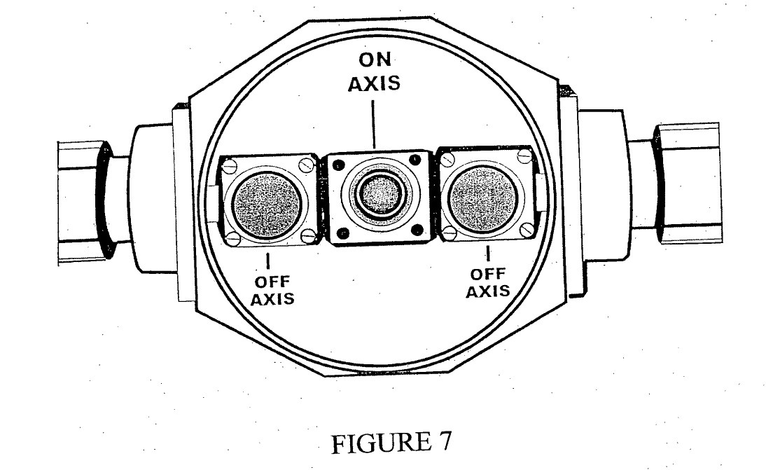

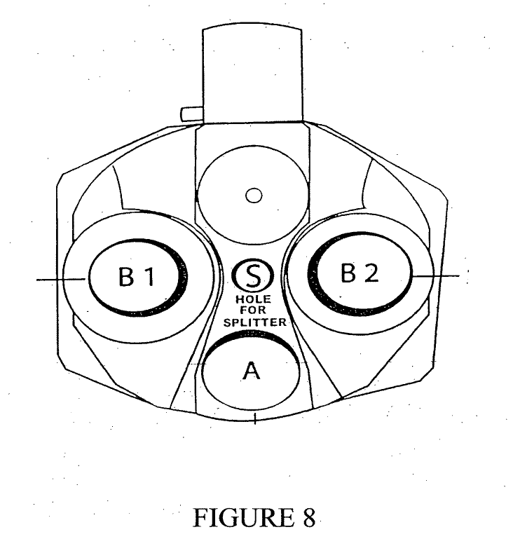

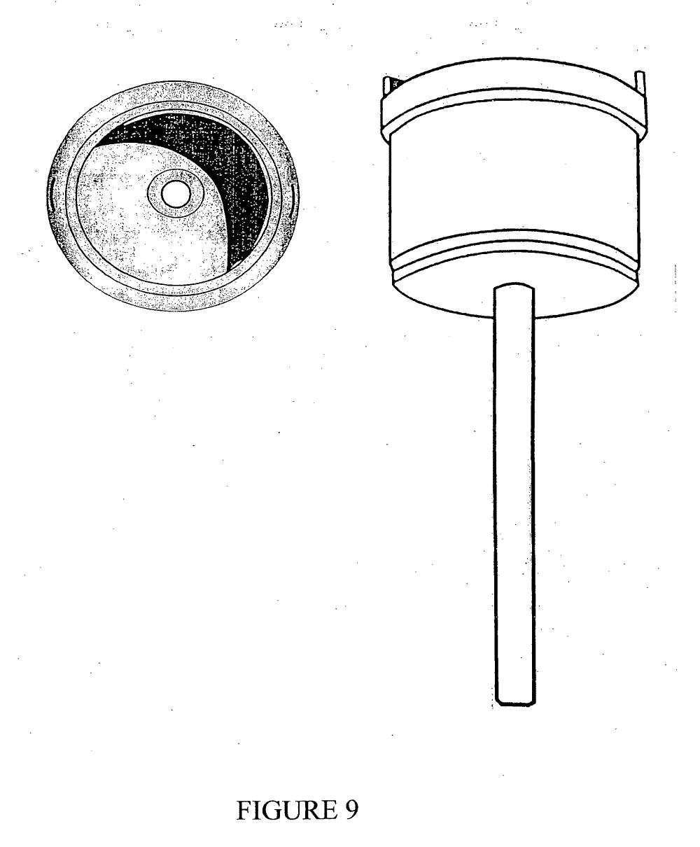

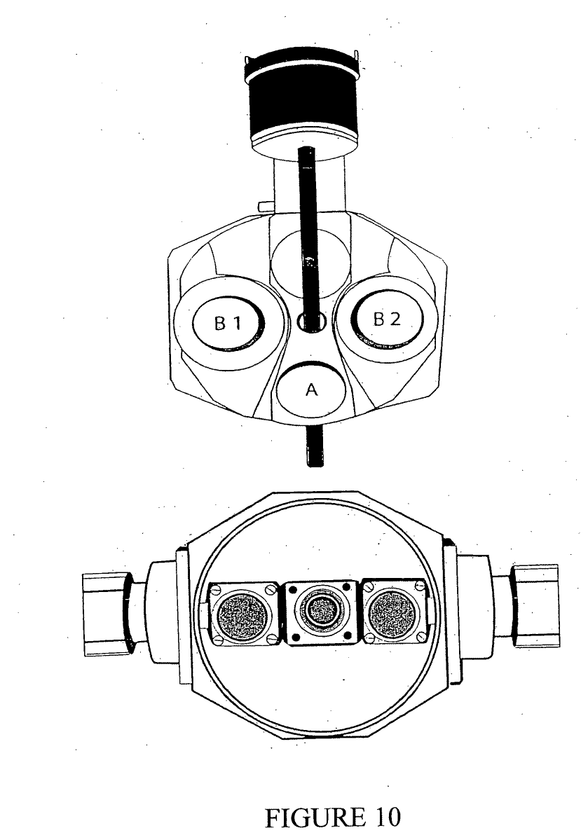

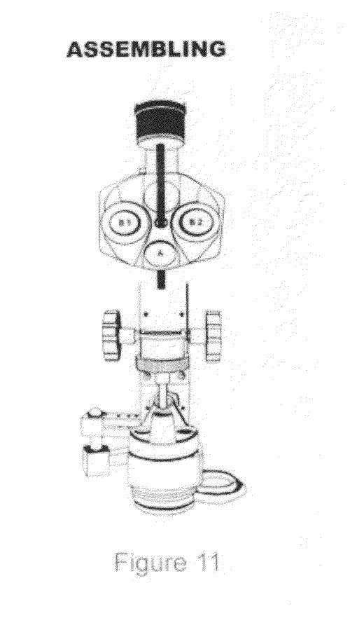

FIG. 2 depicts an electronically controlled navigational microscope for neuro surgery, where image can float from microscope to computer for matching or image can be floated from computer to be super-imposed on eye-piece of microscope to facilitate operating surgeon to review relative and incomplete observation of object.

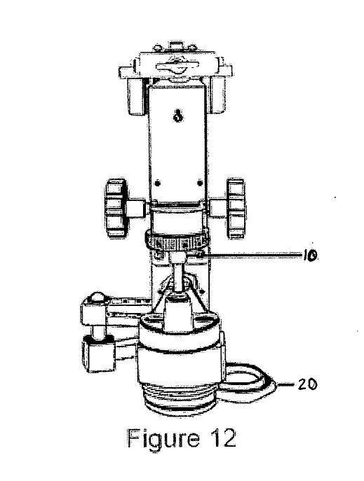

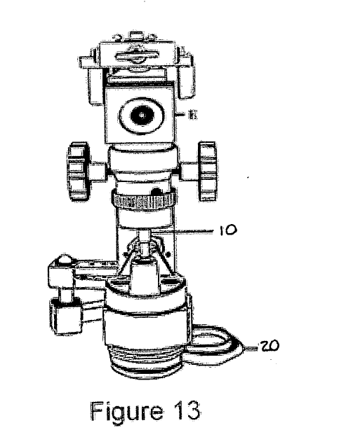

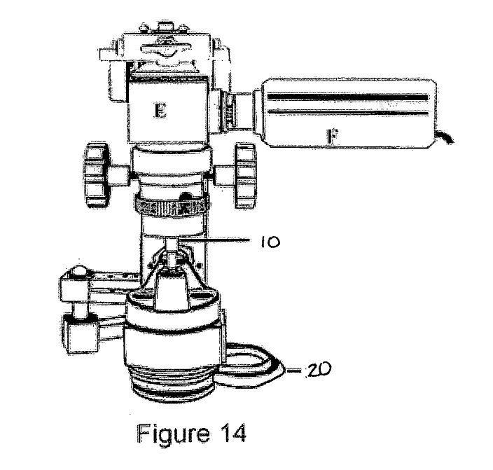

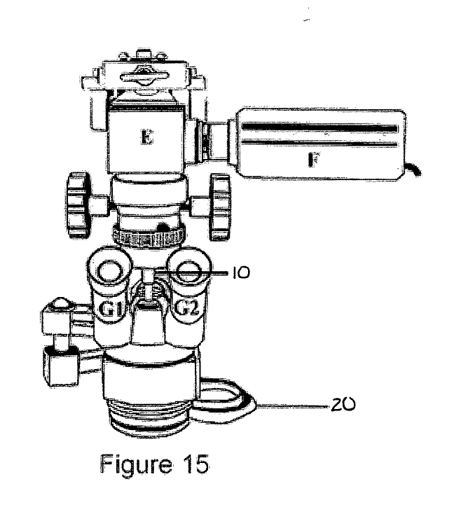

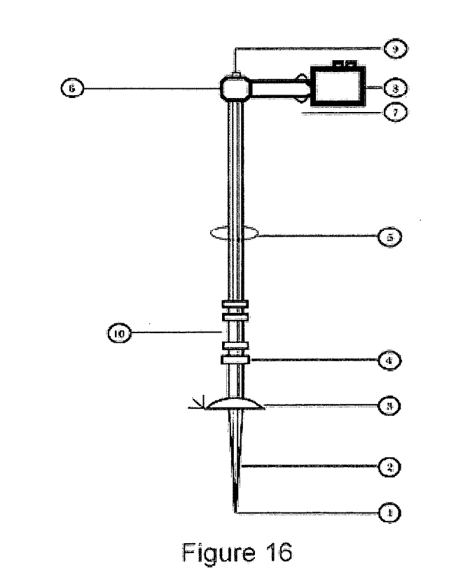

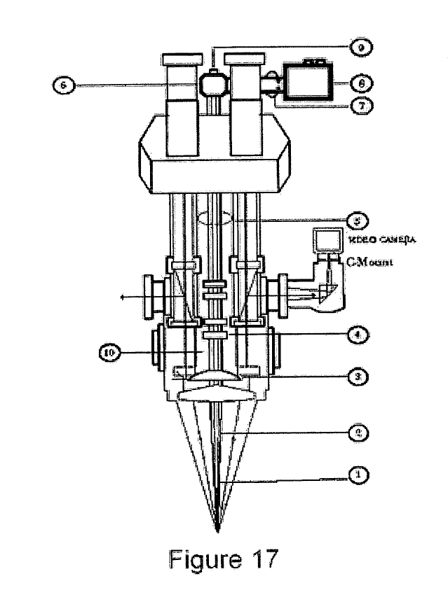

FIG. 3 depicts a surgeon is reviewing the future surgical plan by examining orthogonally captured image of human cornea.

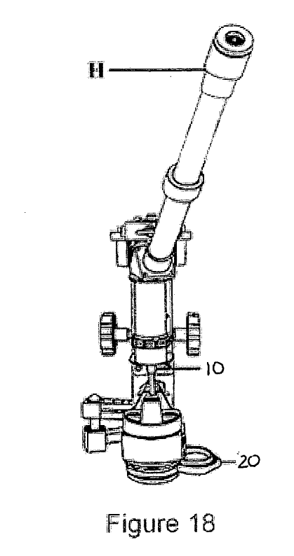

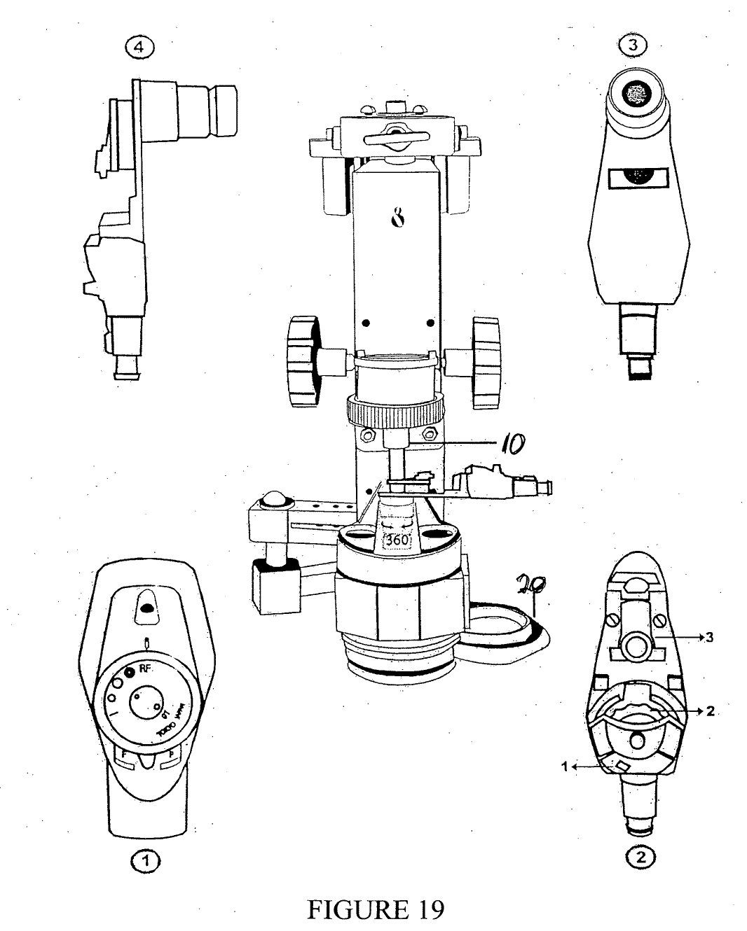

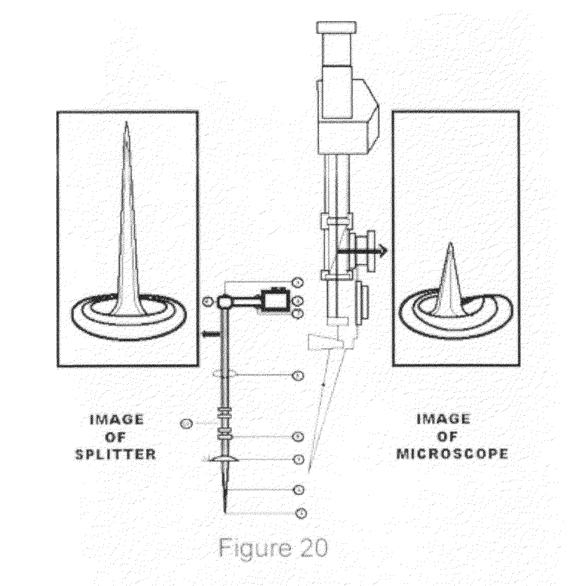

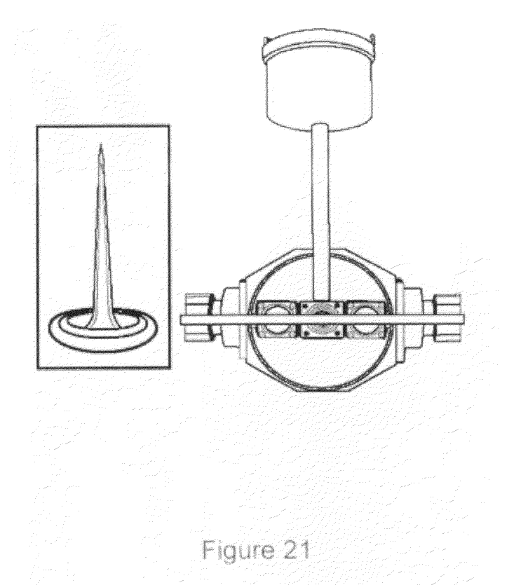

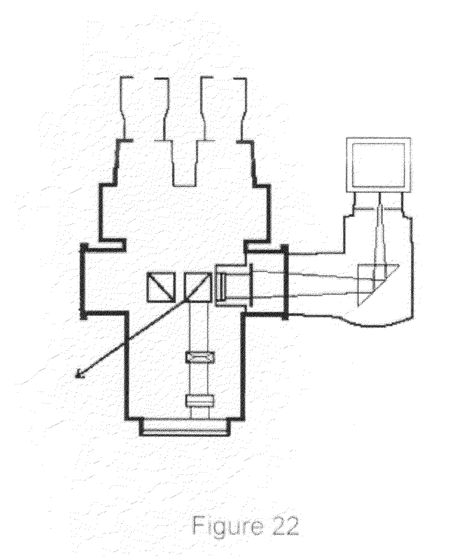

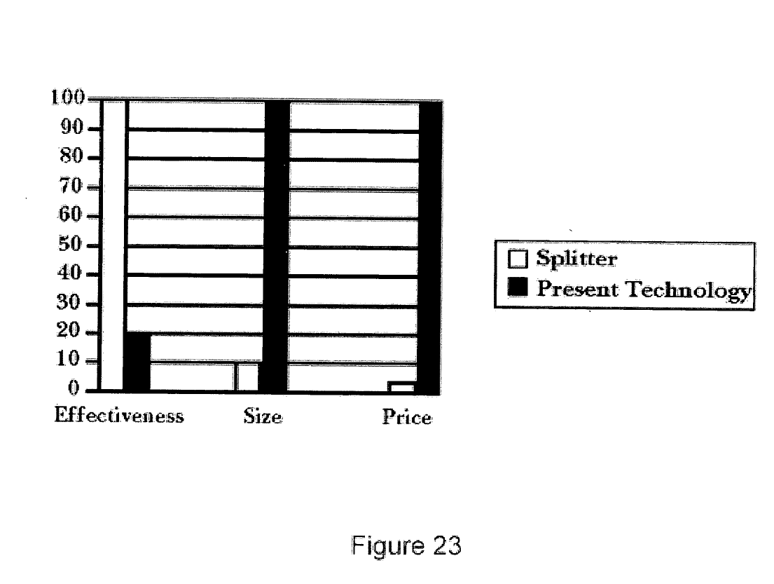

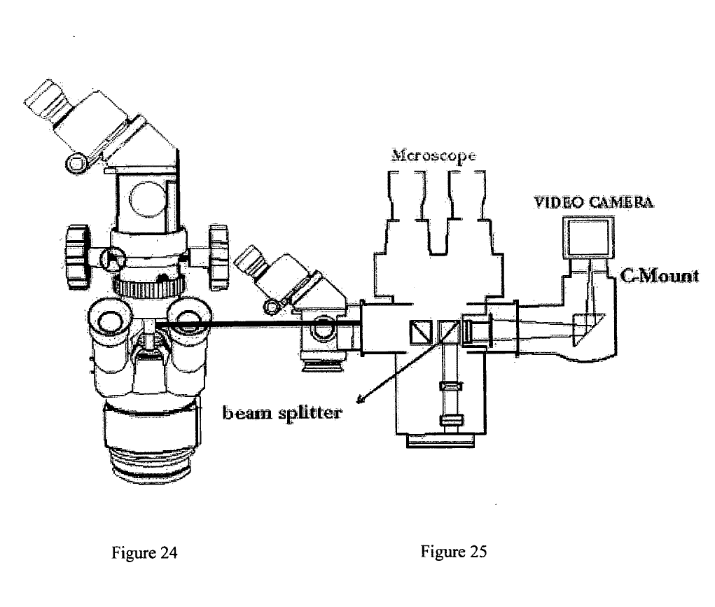

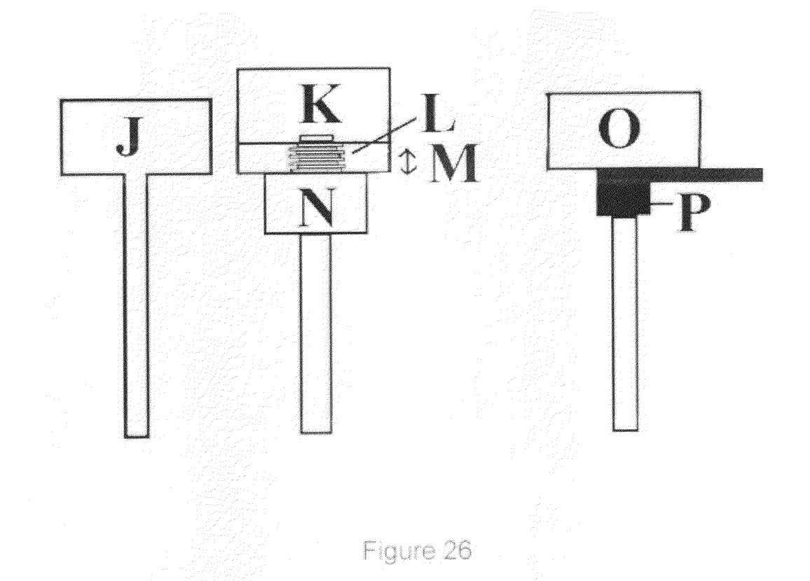

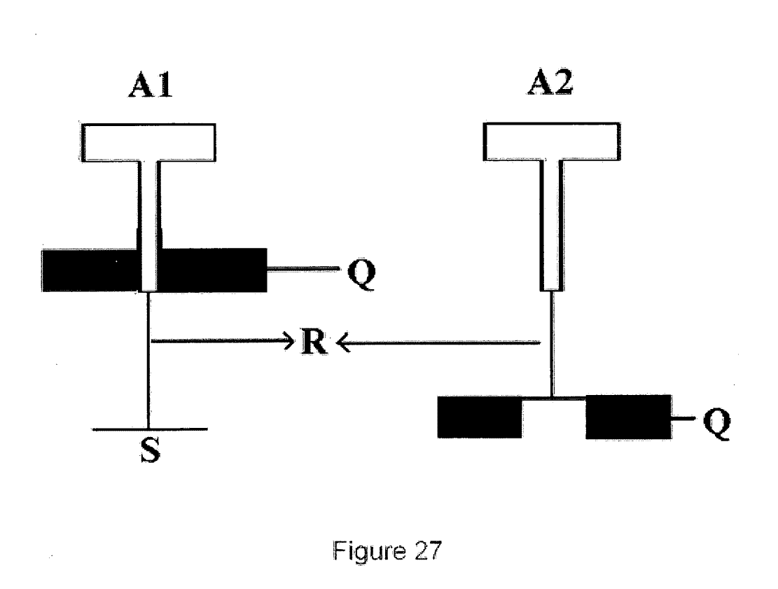

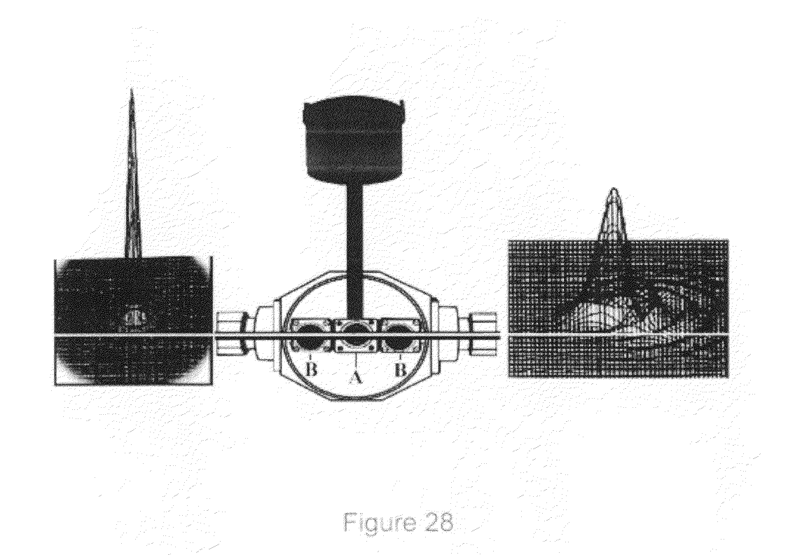

FIG. 1, 2, 3 are showing existing technologies which were source of inspiration for SPLITTER
FIG. 4 shows orthogonal visual bi-directionality created by SPLITTER.

### FIG. 6 “FABRICATION”

DRAWING 1 shows bottom perspective view of existing three-step magnification microscope with two optical chambers together with the available space to construct a new independent mobile optical chamber of same optical power as that of existing microscope for splitter.
DRAWING 2 shows how the existing lever of two optical chambers is changed into a lever to accommodate third optical chamber for splitter for independent focusing with independent lever with micro gear (as pointed by arrow ‘A’) on the micro-gear strip of optical chamber as pointed out with arrow ‘B’.
DRAWING 3 special optical chamber with micro-gear strip (as pointed by arrow).
   FIG. 7 shows bottom perspective view of existing three steps microscope especially improvised for splitter by addition of on axis optical chamber added between two already existing optical chambers marked by ‘B’.
   FIG. 8 is a top plan view of a microscope showing two already existing holes ‘B1’ and ‘B2’ for eyepieces and two additional holes one labelled “S” for a SPLITTER and one labelled “A” for a pattern projector.
   FIG. 9 shows top ‘A1’ and lateral view ‘A2’ of splitter and as shown in FIG. 8, a hole in a microscope for insertion of the splitter.
   FIGS. 10, 11 show how a SPLITTER is installed in existing microscope
   FIG. 12 depicts a Stage 1 of SPLITTER 10 in a microscope along with specially, exclusively designed X-Y-Z translation 20 for splitter 10.
   FIG. 13 depicts a Stage 2 of a microscope with a splitter 10 and a mount adapter C.
   FIG. 14 depicts a Stage 3 of a video camera ‘F’ attached to C-Mount adapter ‘E’.
   FIG. 15 depicts a Stage 4 of a microscope having eyepieces ‘G1’ and ‘G2’ attached on either side of a centrally mounted splitter 10.
   FIG. 16 is a schematic presentation of a presently preferred embodiment of a SPLITTER together with an image of pure resolution produced thereby.
   FIG. 17 schematic presentations of an existing microscope with a SPLITTER in accordance with a presently preferred embodiment with its necessary attachments
   FIG. 18 Shows how easily optical accessories here mono-ocular microscope ‘H’ can be attached to the head of splitter ‘A’
   FIG. 19 shows an opthalmoscope with an attached splitter 10.
   DRAWING 1 shows head of opthalmoscope with the normal patterns used to examine human fundus. (inside of the eye)
   DRAWING 2 depicts a head of an opthalmoscope having a lever 1 to change patterns; sockets 2 where patterns are framed; and a prism 3 to direct patterns at right angle;
   DRAWING 3 a tube attached to the front side of the ophthalmic head (FIG. 8); and
   DRAWING 4 lateral view of pattern projector.

Pattern projector is tapered in conical shape with a purpose to allow inter pupillary adjustment of eyepieces.

An exclusive X, Y, Z translation is designed to operate mechanically for SPLITTER to increase orthogonal scrutinization and operative range.

FIG. 20: Explicitly displays configurational and geometrical differences of images retrieved through splitter on the left side and conventional microscope on right side.

| The image of SPLITTER | Image of Microscope |
|---|---|
| The real time and space are enfolded | Relative time and space, |
| evenly in magnification and | magnification and resolution are |
| magnification is symmetrically | unevenly juxtaposed (placed |
| embedded in resolution. | side by side). |
| | Please also refer to FIG. # 22 |

FIG. 21: Geometrical symmetry between the paradigm of ‘orthogonality’ and structural relationship of SPLITTER with its unique magnification system and the retrieved image.
FIG. 22: Shows how non-orthogonal dimensions generate partial and incomplete image through the lateral outlet of the microscope, here ‘I’ is the beam splitter ‘E’ is the C-Mount adopter and ‘F’ is the video camera.
FIG. 23: How SPLITTER enhances the workability of complimentary technology.
1. Effectiveness: comparison is based upon relationship between resolution and magnification.
2. Size: SPLITTER can be installed in any small sized microscope without any obstruction in existing structural configuration and functions, SPLITTER rarefies half of the optical parts of microscope used to retrieve image and extends in vertical dimension by accepting any available optical (E.g. binocular microscope) and therapeutic (E.g. laser) accessories. When presently microscopes are extended horizontally (FIG. 24) to make ways for accessories which cost thousands of dollars per sq. inch (reason for low price).

The functional location of orthogonality rarefies many optical parts of microscope for example beam splitter and shifts horizontal extension of accessories into vertical dimensions to keep the size of microscope as small as possible, as if nothing exists between human eyes and object which is one of the prime quality of orthogonality.

Incidentally the relationship of effectiveness is also the prime indicator that how SPLITTER extends the accompanying technology into future.

FIGS. 24-25: How Splitter creates quantum shift in configuration of optional accessories.
1. How hollow tube of a splitter creates quantum shift of horizontal expansion for accessories into vertical direction and the functions of the beam splitter of the present microscope demarcated by white border are replaced by vertical tube of external diameter of 6.2 mm only.
2. The monocular microscope attached vertically to the splitter can be replaced by binocular microscope attached horizontally to the existing microscope.

### FIG. 26: REASONS TO DESIGN SEAMLESS TUBE OF SPLITTER

J: A seamless tube is a joint-less, en-block, lathe-cut from hard material to provide uniform strength. (Refer FIG. 1)
K-L-M-N: A joint was intentionally avoided on the technical advice of designing engineer because joint is a weakest part of a tool and to make a joint you need a thick plate of splitter's head and an extra collar to support the tube and to keep the optical axis in alignment which was not possible without creating hindrance in the smooth alignment and functionality of microscope.

Another reason for avoiding a joint is that delicate splitter's tube has to accommodate heavy optional accessories and freely rotate at 360 degrees around its own optical axis. (Refer FIG. 2)

O-P: Because no support was available in the microscope to install the tube, a support in the form of round socket was designed to allow free rotation of tube and to bear weights of optional accessories. (Refer FIG. 3)

A seamless tube is also the basic requirements when precision, critical alignment and aesthetics are the requirements.

FIG. 27: Various applications of Splitter.

Either SPLITTER ‘A1’ operates with a technology ‘Q’ on a common object ‘S’ if orthogonally placed ‘R’ or it operates on technology (e.g. Lathe machine) taken as an object if its relationship is orthogonal ‘R’ as show in ‘A2’.

FIG. 28: Relationship and comparison of orthogonal and non-orthogonal images with operating orthogonality of SPLITTER.

Brief Description of Splitter's Optical Components
1. On axis (FIG. 7)
2. Orthogonal image retrieving system
3. Independent X, Y, Z translation
4. Independent system of fine focusing
5. 360° scanning and alignment system
6. C-Mount adapter
7. 360° guiding and alignment system
8. Video camera
9. Pattern projector for simple object analysis and operation
10. Central optical beam used for C-Mount adapter or other optional accessories or projection of halogen/xenon lights or laser application or patterns projection

### Splitter:

This can be truly called “sheet anchor” of innovation, which is a seamless tube with head to accommodate multiple accessories.

Seamless length and breadth of ‘Splitter’ has no innovative priorities or scientific values. It was simply an irreconcilable fate that every microscope has very small and safe space to install hollow tube.

Seamlessness, length of tube and internal diameter has no scientific foundations or innovative priorities; tube must conform orthogonal geometry in static mode and capture the very spirit of orthogonal functionality in dynamic mode. Internal diameter should match the smallest aperture of C-mount adopter.

Beside axiomatizing orthogonality the other mechanical and functional applications of splitter are
I. It provides strength to bear weight of accessories and to keep the optical axis in absolute verticality,
II. To pick up crisp and real image without any optical accessories e.g. beam splitter, at low illumination
III. To protect surgeons eyes if tube is used for xenon light or laser therapy

When C-Mount camera is attached with C-Mount adapter it becomes a video camera.

Because SPLITTER operates with its independent vertical optical axis which transcends accompanying technology with replicable view it can help us

1. Optically for

(a) infinite focusing

(b) infinite depth of perception

(c) infinite optical proportionality

(d) pure resolution

2. Functionally for

(a) self identification

(b) self centration

(c) self articulation

(d) self manipulation

(e) self automation or complete robot operation

After shifting Image taking optics of C-Mount Adopter away from the hollow tube with a lever, the hollow optical port can be used for un-interrupted.
1. Projection of patterns on objects. E.g. by projecting concentric circles on spherical characteristic of an object can be measured in micro-millimetres.
2. Calculated application of laser therapy as laser is universally used to change the refractive power of the cornea and also for treating superficial and deep cancer growths.

The length of the tube differs when it is used in zoom microscope or three step magnification microscope. In both these microscopes it occupies “con focal” position or operates on principal optical axis” to provide three-dimensional universal images readable at all times. The internal diameter of the tube may vary from 4 to 8 millimeters and corresponds to the length of splitter which may vary from 8 cm to 30 cm. whereas the outer diameter may vary from 8 mm to 2 cm. Every instrument with which the splitter is used has different dimensions and thus the dimensions of the splitter will vary depending upon, for example, the availability of space; the strength of the material from which it is going to be Lathe cut; and the use of the splitter whether it is used inside or outside of the instrument.

In three-step magnification microscope for splitter to operate on principal optical axis, a separate optical port With movable magnification chamber is designed to concomitantly move with the operating microscope yet with independent focusing, see optical parts No. 1, 2, 3, 4, and S in FIG. 6.

### Major Innovations Carried Out for “Splitter”:

1. fabricating “central magnification optical chamber” for “on axis” image, see FIGS. 6 and 7.
2. retrieving real image in real time at low illumination without any optical parts through narrow tube (internal diameter 4.25 millimetre) totally matching in size to image of existing microscope, see FIGS. 8, 9 10 and 11.
3. Patterns projector to help computer in object analysis and operator in operation, see FIG. 19.
4. Elimination of all optical accessories like mon-ocular microscope, bin-ocular microscope, beams splitter etc.
5. Splitter can also be used for patterns projections; halogen light, and xenon light, laser applications alter opening optical port with a lever.
Forces that Keep “Splitter” in Advance Time Zones:—
1. Orthogonality keeps changeless “relationship” between object and image because of central magnification optical chamber (FIG. 7) and splitter (FIG. 9).
2. An ordinary video camera provides unbroken continuity to “relationship” to furnish true “visuals” (FIG. 15).
3. Computer analyses these visuals” in operative guidelines (FIG. 4).
4. Projection of patterns (FIG. 19) helps computer analysis and operators execution simple, and also completes paradigm of bidirectionality.

### DEFINITIONS OF IMPORTANT TERMS

1. Whole: This can be totally analyzed and holistically viewed.
2. Real time: When you observe, analyze and act in the same time (instant).
3. Dead time: Gap in the continuity when operator is not working with machine.
4. Induction: When creative impulses come from periphery to centre. (Example: neuro surgical microscope).
5. Deduction: when creative impulses operate from centre to periphery. (Example: operating on map captured orthogonally)
6. Universal paradigm: when you do not have any choice irrespective of your experience but to obey operative directions.
7. Centred optical system; where all refracting and reflecting surfaces have their centre on a common axis and there is complete point, line and plane correspondence between object and image because all travelling rays of image are restricted close to optical axis.
8. Timeless Image: Where you do not require a single space dimension to construct and single time duration to complete the image.
9. Truth: Transparent without contradiction.
10. Temporal world: Serial world.
11. A temporal world: Real world/timeless world.
12 Conjugate: Joined in real reciprocal relation, thus if “I” is image of “0” then if “I” is made the object the image would be “0”.

Having described the present invention with respect to certain embodiments thereof, it would be obvious to those of ordinary skill in the art to make modifications and changes thereto using the teachings contained herein.

I claim:

1. An optical splitter providing advance guidance in real time and space, through: universally readable parameters comprising a seamless tube having a head to accommodate multiple accessories.

2. The optical splitter as claimed in claim 1, wherein said seamless tube has an internal diameter of 4.25 millimeter and an outer diameter of 6.5 millimeter such that only a 7 millimeter hole in the center of a microscope is required to operate.

3. The optical splitter as claimed in claim 1 wherein the length of seamless tube differs when it is used in a zoom microscope or in a three-step magnification microscope, wherein in both these microscopes said seamless tube occupies a Co focal position operating on the principal optical axis of the corresponding microscope such as to provide three-dimensional universal images readable at all time.

4. A process for fabricating a central magnification optical chamber for an on axis image comprising making a hole of 7 millimeter in the center of a microscope and inserting the seamless tube as claimed in claim 1.

5. A method for retrieving an image in real time at low illumination without any optical parts through the seamless tube as claimed in claim 1 so as to totally match in size an image of an existing microscope.

6. A three-step magnification microscope with splitter as claimed in claim 1 to operate on principal optical axis, a separate optical port with movable magnification chamber that concomitantly moves with the microscope yet with independent focusing.

7. The use of the Splitter as claimed in claim 1 for patterns projections, halogen light, and xenon light, laser application after opening optical port with a lever.

8. The use of the optical device as claimed in claim 1 which can be attached to any working tool used for measurements, examination, critical analysis, operation, production or creation provided the relationship between objects and working tool is orthogonal.

9. An optical gadget that is attachable along a control optical axis of an orthogonal system that includes a housing comprise an elongate hollow tube having a constant internal diameter; and a mount that attaches said tube to the orthogonal system housing along the central optical axis thereof.

10. An optical gadget as claimed in claim 9 wherein said tube internal diameter is from 4 to 8 millimeters.

11. An optical gadget as claimed in claim 10 wherein said tube internal diameter is 4.25 millimetres.

12. An optical gadget as claimed in claim 9 wherein said tube is jointless and seamless.

13. An optical gadget as claimed in claim 10 wherein said tube is one piece that has been lathe-cut from a hard material and has a length from 8 cm to 30 cm.

14. An optical gadget as claimed in claim 13 wherein said tube has an outer diameter that can vary from 8 millimetres to 2 centimeters.
